(19) United States
(12) Patent Application Publication
(10) Pub. No.: US 2005/0129835 A1
(43) Pub. Date: Jun. 16, 2005

(54) High protein content food supplement

(76) Inventor: Donald W. Delahanty, JR., Gahanna, OH (US)

Correspondence Address: Attention: Sean M. Casey;Sean M. Casey Co., L.P.A., P.O. Box 710, New Albany, OH, 43054-0710, US

(21) Appl. No.: 10/734,955

(22) Filed: Dec. 12, 2003

(51) Int. Cl. A23J 1/00

(52) U.S. Cl. 426/656

(57) ABSTRACT

The present invention is based in part upon the discovery that the manufacture of high-protein foods, food supplements, and food additives can present improved organoleptic properties with significantly greater protein concentrations that previously available. The formulations incorporate only minimal artificial and manufactured food components and are typically exemplified in a protein-maximized, fat and carbohydrate minimized liquid or frozen food supplement composition than can also be modified to the form of a dried powder or granulated product as well as a frozen yogurt, pudding, ice cream, sherbet, or sorbet that may include as little as 20% and as much as 70% by weight of a water soluble protein, as well as sweetening, flavoring, and coloring agents, all based in an aqueous emulsifying dispersion.

### TECHNICAL FIELD

This invention relates to organoleptically improved high protein content food supplements and methods and kits therefore, all of which are especially well-suited for a variety of protein optimized dietetic objectives that can include strength and fitness training tailored diet plans, medically driven nutritional profiles, and other types of goal-optimized and protein-carbohydrate-fat ratio managed diets.

### BACKGROUND OF THE INVENTION

Many attempts have been made over the years to improve the state of the art of manufactured foods and food supplements to maximize various foodstuff attributes and objectives of interest while maintaining desirable organoleptic properties and while establishing optimized nutritional benefits. Such attempts have also endeavored to appeal to the widest array of taste conscious and benefit-seeking consumers. Such attempts have been particularly replete in the art of fitness and medical health related manufactured foods and supplements.

Once such recent attempt has been directed towards such foods and supplements in the form of the expandable food compositions described in U.S. Pat. No. 4,395,429 to Campagne et al. Here, Campagne et al. are concerned with limited application expandable milk and fruit juice combination mousse substrates that can be stored for long periods of time in an acid pH formulation without curdling of the milk component. After such long-duration storage, the substrate is expanded with milk or water for use in various food substrates, edible compositions, and instant dessert preparations. One of the significant drawbacks of the Campagne et al. approach is that it requires the implementation of sophisticated lactoserum protein extraction techniques that can only be accomplished with complex ion-exchange devices. As a result, the Campagne et al. invention is available to and susceptible for use with only a very select group of food processing methodologies.

Others have attempted specifically to improve the state of the art of preparing and storing various types of frozen dessert foods. In U.S. Pat. No. 4,400,406 to Morley et al., a whipped frozen dessert product is disclosed that is characterized as a soft serve type ice cream product, which is compatible for storage in the lower temperature environments of home and commercial freezers. However, to achieve that objective, Morley et al. have described a product that must be manufactured using multiple stabilizers, multiple emulsifiers, and multiple sugars, which can be a marked disadvantage in applications where nutritional value and carefully established protein-fat-carbohydrate objectives drive the product design in ways that significantly narrow the types of such sugars, emulsifiers, and stabilizers that can be incorporated. Trumbetas et al. describe in U.S. Pat. No. 4,411,926 similarly limited stabilized frozen foam emulsions that require dehydration, rehydration, and multiple pre-freezing mixing and heating steps, which can combine to increase the cost of manufacture and to decrease the organoleptically desirable properties of food stuffs prepared with fewer processing steps and with fewer additives.

In yet other attempts to move the state of the art forward, still other inventors have sought to minimize manufacturing materiel costs while maintaining preferred nutritional benefits and organoleptic properties of a low fat, high protein content frozen dessert. One such attempt is disclosed by Morris in his U.S. Pat. No. 4,435,439, which is restricted to a frozen dessert product having a chief aim, among others, to minimize materiel costs by maximizing overrun by incorporating air into the product by as much as 50% air by volume. In addition to the materiel cost savings sought in the '439 patent, Stinger et al. in U.S. Pat. No. 4,855,156 is interested in fat and oil component minimization for such frozen dessert compositions and in achieving better mixing of protein and fruit juice components by mixing after pasteurization. Singer et al. propose to improve the art by replacing the oils, or milk or vegetable fats with denatured whey protein particles to achieve the flavor and feel of full fat ice cream compositions.

Yet further attempts at improvements are described in U.S. Pat. No. 5,308,628 to Schol et al., which are limited to frozen yogurt and dairy desserts formulated without thickeners such as microcrystalline cellulose and similarly capable materials, but with replacement components that embed further respective preparation and processing costs and difficulties in place those otherwise associated with other thickening methods and components.

Another frozen dessert product is disclosed by Brake et al. in U.S. Pat. No. 6,432,466 B1, which is limited to attempts aimed at producing smooth and creamy sorbet-type desserts that do not present the usually iced organoleptic properties most commonly known to those skilled in the arts of such sorbet preparations. However, the Brake et al. efforts are restricted to high-sugar content products that can be less than desirable in many respects to those seeking to avoid high-sugar-content foods in favor high-nutrition value foods and supplements that are low in ineffective carbohydrates and deleterious fats and high in useful proteins, vitamins, and minerals.

Frank del Valle considers many of the shortcomings in the preceding disclosures and attempts in his invention that is described in U.S. Pat. No. 6,558,731 B1, which is limited to a high protein frozen food product that suffers from many of the same failings of other prior art compositions. While del Valle appears to focus on improving the art by minimizing available carbohydrate content of the frozen food product, he adopts and incorporates many of the same components and methods of prior attempts while incorporating higher protein content and while substituting artificial sweeteners, among other changes.

Still others seek to advance the art with pourable, higher protein liquid dessert compositions that can be stored in liquid form prior to use and freezing such as those described in U.S. Pat. No. 6,569,485 B2 to Hussein, and in U.S. Pat. No. 6,635,302 B1 to Huang et al.

While purporting to improve the state of the art of preparing large quantities of processed frozen dessert products, it has been found that the above-described methods and compositions also suffer from the same over-processing problems that continue to plague the art. The previous methods and compositions not only require sophisticated machinery and methods for production, but that the final products have less than optimum organoleptic properties including flavor and mouth feel, which appears to be a direct result of over-processing the various compositions.

What continues to be needed and what is entirely absent in the prior art are compositions that can be used for, among other purposes, preparing high protein, low fat, low carbohydrate frozen and liquid dessert compositions that are suitable for a variety of dietetically tailored and optimized food supplement products. Such products are preferably capable of presenting protein content by weight in excess of the amounts of protein previously available to consumers of such high-protein content compositions of the prior art. Further, what remains desirable but unavailable in the prior art are such high-protein content food supplements that also offer preferable organoleptic properties of smooth mouth feel and good flavor but that lack the graininess often associated with previous known high-protein content food stuffs. The high protein food supplements of the instant invention advance the state of the art using new and novel compositions that achieve unexpectedly satisfactory organoleptic properties. Even further, the compositions of the instant invention also demonstrate good shelf life and can be prepared using less-expensive manufacturing methods and techniques, and using fewer and more nutritionally valuable raw materials and ingredients.

### SUMMARY OF INVENTION

In its most general configurations, the present invention addresses the problems in the art and advances the state of the relevant technology with a variety of new formulations and compositions that improve prior liquid and frozen food supplements in new and novel ways. In one of the many preferable configurations, the invention incorporates a protein-maximized liquid and or frozen or sherbet or sorbet type food supplement composition that minimizes fats and carbohydrates. The composition can incorporate, among other constituents, between about 30% and about 65% by weight water-soluble protein, less than about 3% by weight of a non-nutritive intense sweetening agent, between about 0.1% and about 5% by weight of a flavoring agent, and between about 27% and about 70% by weight of an aqueous emulsifying dispersion.

While many possible constituent ingredients are contemplated for use in the instant compositions, one preferable type of protein can include various types of albumin, whey, beef, pork, fish, poultry, egg, vegetable, and soy protein compositions such as those described herein below in more detail. One of many preferred protein compositions are those disclosed in U.S. Pat. Nos. 6,221,836; 6,008,252; 5,919,767; 5,889,040; 5,756,469; and 5,716,926; all to Paxton King Beale, which are each incorporated by reference in their entirety as if fully set forth herein. These protein compositions, among other similarly adapted compositions, can include further beneficial substances and can have many benefits in that they closely parallel the amino acid profile of human muscle tissues and in that they are configured to optimally increase the protein concentration in users of the instant invention. Of the many possibly preferable forms of protein available and compatible for use with the present invention, many athletically tailored embodiments of the instant invention will preferably include one or more types of partially hydrolyzed protein compositions as such have been found to be more easily digested and absorbed thus increasing the benefit to the user.

For purposes of establishing compatibility for use with a variety of dietetically optimized regimens, various types of non-digestible, non-nutritive, and or non-carbohydrate but intense sweeteners or sweetening agents have been found to be effective for use with the present invention. Of the sucrose-derivative, saccharin, and aspartame type sweeteners presently known to those skilled in the related arts, one type of intense sweetener (i.e. having substantially more perceptible sweetening effect that that of table sugar, often times with a comparably smaller volumetric quantity of the intense sweetener or sweetening agent) that has been found to be particularly well-suited to the inventive applications, includes for purposes of example but not for purposes of limitation, what is referred to by those skilled in the art as a sucrose derivative known to those skilled in the art as sucralose.

The preferred flavoring agents can include any of a wide variety of flavors that may be possibly desirable by consumers of the supplements of the instant invention. Some particularly desirable flavoring agents that are described in more detail below include, for purposes of example without limitation, cocoa bean powders and extracts, and vanilla extract. Many other acidic and pH neutralized flavoring agents have also been found to be satisfactory for purposes of refining the taste of the products of the invention to meet the preferences of consumers. Such other flavoring agents can include fruit and confectionary flavors that can be used alone or in various combinations to best adapt the inventive compositions contemplated herein for the intended purposes. Acidic, basic, and pH neutralized or managed flavoring agents can be adapted to ensure that they do not unexpectedly affect the organoleptic properties of the finished food product by inducing undesirable crystallization, curdling, or other equally non-preferred effects.

The instant invention also preferably incorporates the aqueous emulsifying dispersion in any number of possibly preferred constituent component compositions that can include, without limitation but for purposes of example, soy and diary milks and dispersions and serums thereof, as well as a host of other types of aqueous emulsifying dispersions that can be equally desirable and effective for purposes of preparing the inventive compositions of the invention. As those skilled in the art can further come to comprehend, use of various soy and dairy-based components of the aqueous emulsifying dispersion can further increase the available protein that can be ingested with the compositions of the invention. More particularly, with various types of dairy milk products, the inventive compositions can be preferably or optionally be further enhanced with a higher overall protein content that results from the approximately 2% to about 8% by weight of dairy protein that is available in such products.

Those knowledgeable in the relevant arts also refer to what is here termed the aqueous emulsifying dispersion as oil-in-water emulsions, colloid suspensions, and solutions of various related components, all of which can include plasmas, serums, lipids, proteins, and other constituents commonly found and or incorporated into such aqueous emulsifying dispersions. Various types of commercial and retail milk-type aqueous emulsifying dispersions are particularly well-suited to the embodiments of the instant invention and can include regular and condensed milk-type products that can be formulated to have between about 30% to about 90% of water, between about 1% and about 6% proteins, between about 0.1% and about 8% fat solids, and various other constituent sugars, minerals, vitamins, acids, and enzymes. The instant invention is also further directed to embodiments that can preferably or optionally include the aqueous emulsifying dispersion to have an organoleptically enhancing reduced fat content milk composition that be formed from dairy and or soy sources.

In optional or preferred alternative variations of any of the preceding embodiments, the instant invention also further contemplates protein-maximized, fat and carbohydrate minimized liquid food supplement compositions wherein the between about 30% and about 65% by weight of water soluble protein includes an amino acid profile with between about 4.5% and about 8.0% by weight of alanine, between about 2.6% and about 8.6% by weight of arginine, between about 5.0% and about 9.5% by weight of aspartic acid, between about 0.1% and about 5.0% by weight of cystine, between about 12.0% and about 17.0% by weight of glutamic acid, between about 2.0% and about 6.0% by weight of glycine, between about 1.5% and about 4.0% by weight of histidine, between about 3.0% and about 5.5% by weight of isoleucine, between about 7.5% and about 11.0% by weight of leucine, between about 7.0% and about 10.5% by weight of lysine, between about 1.5% and about 2.5% by weight of methionine, between about 4.5% and about 8.0% by weight of phenylalanine, between about 4.0% and about 15% by weight of proline, between about 4.0% and about 9.0% by weight of serine, between about 3.5% and about 8.5% by weight of threonine, between about 0.5% and about 3.0% by weight of tryptophan, between about 1.5% and about 4.5% by weight of tyrosine, and between about 5.0% and about 8.5% by weight of valine.

In yet other more preferred or optionally modifications to any of the preceding embodiments, the protein-maximized, fat and carbohydrate minimized liquid food supplement compositions may also further incorporate a dietetically effective amount of a pyruvate compound, which include a pyruval-creatine, and calcium, potassium, or magnesium pyruvate or mixtures thereof. A dietetically effective amount has been found to depend upon many variables specific to the individual using the compositions of the instant invention. Such specific variables can include, for purposes of example without limitation, the body weight, the categories and caloric totals of the food consumed thereby, and the nature and extent of any food supplements taken periodically and or regularly, as well as the particular fitness level of and training undertaken thereby.

In adult males aged between about 20 to about 35 years of age, weighing about 80 to about 90 kilograms with an average musculature and body fat content, it is preferred that a dietetically effective and physiologically effective and beneficial amount of the pyruvate compound in combination with the protein content contemplated herein should be at least between about 3 grams and about 300 grams per a day or more or less, and even more preferably about 1 to about 5 grams per kilogram of body weight. While many types of possible pyruvate compositions and pyruval-type compounds exist, those pyruvates disclosed in the above described U.S. Pat. Nos. 6,221,836; 6,008,252; 5,919,767; 5,889,040; 5,756,469; and 5,716,926 have been found to be well adapted for purposes of use with the instant invention.

The present invention also further contemplates additional modifications, compositions, and alternative variations wherein the non-nutritive intense sweetening agent is a sucralose. In yet more possibly preferable arrangements, the instant invention also further contemplates embodiments wherein the aqueous emulsifying dispersion preferably incorporates a powdered, hydrated carrageenan and or lecithin component in an amount of between about 1% and about 20% by weight of the food supplement composition, and more preferably between about 2% and about 15%, and even more preferably between about 5% and about 10%, and most preferably approximately 7% by weight of the food supplement composition.

With each of these summarized embodiments, and variations, alternatives, and modifications thereto, in mind, those skilled in the art can further appreciate and understand that the instant invention in all of its various arrangements meets various long felt but continually needed improved compositions and methods therefore that overcome the shortcomings of prior art compositions. What to this day continues to elude those hoping to improve the state of the art, is the inexpensive, easy-to-use, and physiologically beneficial food supplements and compositions of the invention that maximize the available protein in the supplement while minimizing fat and carbohydrate content in an organoleptically satisfactory and acceptable-shelf-life formulation.

What is especially noteworthy of the various inventive embodiments is that the instant high protein content food supplement compositions are compatible for use with a wide-array of dietetic applications and are capable of incorporating a wide range of possible constituent components in formulations suitable for many ultimate purposes as foods, food supplements, and food additives in liquid, frozen, gelled, and dried and powdered formulations and compositions. As can be further better understood with reference to the flowing detailed description of the invention, the new and novel formulations of the invention address the many needs that persist in the field with improvements in the state of the art that do not impose any unacceptable costs or increased difficulties.

### DETAILED DESCRIPTION OF THE INVENTION

In a wide range of possible embodiments and modifications and variations thereof, the new and novel protein-maximized, fat and carbohydrate minimized liquid and frozen food supplement compositions contemplated by and according to the features and capabilities of the instant formulations of the invention establish organoleptically improved products having higher-than-previously contemplated or available protein concentrations.

### Disclosure of the Invention

The instant invention is directed to, among other embodiments, protein-maximized liquid and or frozen or sherbet or sorbet type food supplement compositions and formulations that minimize fats and carbohydrates. The inventive composition can also be further adapted as an oral, enteral (including gastric and intestinal feeding tubes and the like), and parenteral food, food supplement, and food additive. For purposes of example but not for purposes of limitation, the many contemplated embodiments, variations, modifications, and alternative compositions can, in addition to the previously described possible configurations, be used as and added to cake, muffin, and pancake mixes, or adapted to be consumed in the form of pills, tablets, food bars, candies, confections, capsules, liquids, or powders.

In one preferred embodiment, the contemplated inventive composition includes, among other components, between about 30% and about 65% by weight water soluble protein, which can be derived from any number of possible protein sources including mammalian dairy proteins such as bovine and other types of milk, meat proteins including beef and pork and fish and poultry, egg proteins, vegetable proteins including soy, and other proteins, and fractions and combinations thereof. The various preferred and optional embodiments of the invention also contemplate the use of genetically engineered plants, animals and or organisms to produce the anabolic water-soluble protein composition, fractions, and constituents.

As described elsewhere herein, in the past, many prior attempts have disclaimed and discounted protein concentrations exceeding about 20% by weight of the overall liquid and frozen food supplement composition mixtures because of problems encountered with gellation during mixing and storing. Additional seemingly insurmountable challenges have also persisted in that organoleptic properties degraded during mixing, freezing, and subsequent storage. More specifically, it was sometimes and often found with past attempts that, over time, a graininess developed in the product much like sandy particles and or that a distasteful protein and or processing flavoring or aroma developed when the product was manufactured with protein concentrations that exceeded about 20% by weight of the total mixture or food supplement composition. However, with the new formulations of the instant invention that include fewer but key ingredients in specified ratios, these undesirable attributes and problems unexpectedly disappeared.

Depending upon the preferred or optionally preferable target diet of the consumer intended for the embodiments of the invention, any one of many possibly suitable types of inert but intense sweeteners or sweetening agents have been demonstrated found to be effective for use in the formulations of the invention. Of the many types of sugar related artificial sweeteners available to those skilled in the art, one of many preferable types of intense sweeteners (i.e. having substantially more perceptible sweetening effect that that of table sugar, often times with a comparably smaller volumetric quantity of the intense sweetener or sweetening agent) that has produced excellent results includes for purposes of example without limitation, the previously described sucralose sugar derivative. This sugar-like but sugar-free and essentially calorie-free intense sweetener or sweetening agent is available commercially as Splenda®, which is supplied by Tate & Lyle, United Kingdom, and Splenda, Inc., Fort Washington, Pa., USA. In sucralose, the sucrose molecule has been modified wherein one or more of certain hydroxyl groups are replaced by chlorine atoms so as to evince a non or low-carbohydrate sweetening effect that can range as high as 600 times more intense per unit volume of comparable traditional sweeteners such as sugar.

However, for purposes of improving workability and usability, the sucralose-based intense sweeteners such as Splenda® have been expanded volumetrically by their respective suppliers with various additives such as maltodextrin so as to enable use of the expanded sucralose, in the form of Splenda®, in the same volumetric quantities that are applicable to the more common refined sugars. While the formulations according to the principles of the invention are described in the context of the Splenda® version of sucralose, those skilled in the relevant arts will appreciate that commercial versions of sucralose are available in concentrations that are far more sweetening that ordinary sugar such that the preferred and optional quantities specified here in connection with the inventive formulations and compositions can be modified accordingly so that much less pure sucralose will be needed than that specified in the context of the Splenda®-based embodiments described herein.

The many benefits of such a sucrose derivative sweetener are described in more detail in Great Britain Patent No. 1,543,167, U.S. Pat. Nos. 4,751,294 and 4,343,934, as well as a host of later issued U.S. patents directed to the same related field of art and compositions. With these types of intense sweeteners and sweetening agents, the instant invention has contemplated embodiments that preferably include less than about 10% by weight of the total mixture or food supplement composition of the intense sweetening agent, and more preferably less than about 7% by weight, and even more preferably less than about 3% by weight may be incorporated.

Many possibly desirable or optionally preferred flavoring agents have been demonstrated to be compatible for use with the instant invention and include nearly limitless possible flavors that are narrowed only by the preferences of the consumers of the innovative compositions of the instant invention. As already noted elsewhere herein, such flavoring agents include but are not limited to cocoa bean powders and extracts, vanilla extract, fruit flavorings, spice flavors, and many others. Additionally preferred and optional embodiments will also incorporate chocolate chips, other types of flavoring chips, dried and hydrated fruit pieces (for example, banana, apple, blueberry pieces), as well as nut powders, liqueur flavoring additives, and the like. With these considerations, the embodiments and compositions according to the instant invention have contemplated flavoring agents including fruit, vanilla, chocolate, and other flavoring agents in amounts preferably ranging between about 0.01% and about 15% by weight of the total mixture or food supplement composition, or more or less, and more preferably between about 0.1% and about 10% by weight, and even more preferably between about 1% and about 5% by weight.

The instant invention also preferably incorporates the aqueous emulsifying dispersion in its liquid and frozen forms, as well as in the precursor forms of the contemplated powdered and granulated forms of the high protein compositions of the invention, to generally include a water-based substance or constituent. Examples of such aqueous emulsifying dispersions and or constituents thereof include soy and diary milks and dispersions and serums thereof, as well as a host of other types of aqueous emulsifying dispersions that can be equally desirable and effective for purposes of preparing the inventive compositions of the invention. As those skilled in the art can further come to comprehend, use of dispersions formulated from various beef, fish, pork, poultry, egg, rice, vegetable, soy, and dairy-based fractions and components and serums thereof as or as part of the aqueous emulsifying dispersion can further increase the available protein that can be presented to the consumer with the compositions of the invention. More particularly, with various types of dairy milk products, the inventive compositions can be preferably or optionally be further enhanced with a higher overall protein content that results from the approximately 1% to about 15% by weight, or more or less, of the constituent beef, rice, vegetable, dairy, or soy protein that is available in such fractions and components. With these considerations in mind, the instant invention contemplates various preferred embodiments and compositions that preferably incorporate in the total mixture or food supplement composition between about 21% and about 80% by weight of an aqueous emulsifying dispersion, and more preferably between about 27% and about 70%, and most preferably between about 35% and about 50% by weight.

As previously discussed in more general terms, in adult males aged between about 20 to about 35 years of age, and weighing about 80 to about 90 kilograms with an average musculature and body fat content, depending upon the exercise regime of the individual and the nutritional and physiological objectives sought thereby, it is often preferred that a dietetically effective and physiologically effective and beneficial amount of the pyruvate compound, in combination with the anabolic water soluble protein content contemplated herein, should be at least between about 1 grams and about 500 grams per a day or more or less, and more preferably between about 81 grams and about 400 grams per day (for a user weighing about 81 kilograms or 180 pounds), and even more preferably between about 1 to about 5 grams per kilogram of body weight per day, or more or less depending upon the physiological profile of the intended mammalian beneficiary and the nature of the intended effect on and benefit to the individual user. Specific forms of pyruvate useful in the present invention include sodium pyruvate, magnesium pyruvate, calcium pyruvate, potassium pyruvate, pyruvyl-glycine, pyruvyl-creatine, pyruvamines, pyruvyl-alanine, pyruvyl-glutamine, pyruvyl-leucine, pyruvyl-valine, pyruvyl-isoleucine, pyruvyl-phenylalanine, pyruvyl-proline, pyruvyl-sarcosine, their amides, esters and salts, and mixtures thereof.

In the context of the inventive embodiments and compositions according the metes and bounds of the instant invention, the preferred amount of pyruvate can also be configured to be proportioned according to the preferred amount of water-soluble and anabolic protein incorporated into the particular inventive embodiment of the invention. In this regard, it has been found that the weight ratio of pyruvate to anabolic water soluble protein may be between about 1:1 to about 1:50, and more preferably between about 1:2 to about 1:30, and even more preferably between about 1:3 to about 1:25, and most preferably between about 1:5 to 1:20. One the many sources of pyruvate available in the marketplace, one particularly effective formulation that is well-sited for the various preferred and optional embodiments of the instant invention include the XAP™ and Body for the Ages™ brand creatine pyruvate supplements, additives, and compositions available from Body for the Ages in San Francisco, Calif., USA, www.bodyfortheages.com.

The present invention also further contemplates preferred and optional embodiments that incorporate one or more types of natural, artificial, and hybrid sweeteners, including, for purposes of example without limitation, the aforementioned non-nutritive intense sweetening agent sucralose or Splenda®. For embodiments of the invention wherein the consumer seeks higher carbohydrate content of the inventive food supplement of the invention, various naturally occurring and naturally originating but refined and processed sweeteners can be used including sugar or sucrose derived substances as well as closely related substances such as fructose, lactose, and other similarly sweetening agents.

In yet more possibly preferable arrangements, the instant invention also further contemplates embodiments wherein the aqueous emulsifying dispersion preferably incorporates an emulsification substance, which can have a flavor of its own, that is added to an aqueous solution to form or to augment the aqueous emulsifying dispersion. The emulsification substance can be, for purposes of example but not for purposes of limitation, a powdered, hydrated carrageenan and or lecithin in an individual or total amount of between about 1% and about 20% by weight of the food supplement composition, and more preferably between about 2% and about 15%, and even more preferably between about 5% and about 10%, and most preferably approximately 7% by weight of the food supplement composition. While the primary benefit of the emulsification substances, such as the lecithin additive, is found by those skilled in the art and by those evaluating the preparations and formulations of the invention, qualitatively and subjectively appears to be improved organoleptic properties such as more preferable smooth mouth feel and better pliability and emulsification of the other constituents, several nutritive and flavor and aroma benefits are perceived.

Many sources of food benefit information concur that lecithin can be especially preferred because it augments the in situ production of the same substance in mammalian livers and is an excellent source of phosphytidal choline and phosphytidal inositol, which are both often advocated to be cognitive enhancing substances having many beneficial effects in humans, which depend upon the user and the respective physiological state thereof. Some other beneficial effects include improved fat metabolization and improved detoxification and elimination of waste products of fat and protein breakdown, which is essential for athletes and those on specially tailored diets.

As has been known to some having knowledge and skill in the relevant arts and technology, many difficulties can be experienced when mixing liquids and solids that respectively consist of dissimilar substances and types of individually varied amounts water, oil, protein, fats, and other substances. Such efforts to mix dissimilar ingredients has often resulted in non-uniform or non-homogenous mixtures that often present lumps of certain of such ingredients that cannot be properly and uniformly mixed together even with extremely high-speed or long-term blending or whipping.

To overcome such problems, those having skill in the chemical, food processing, and culinary arts have developed many customs, procedures, and practices by which such dissimilar and seemingly unmixable types of ingredients can be uniformly and homogenously mixed with one another. Of the many terms customarily in use to describe the results of such practices and procedures, many knowledgeable in the technology refer to the resultant mixture as an emulsification, admixture, dispersion, and the like.

While these terms have classical definitions in various fields of art, such terms here are used to describe the results of the mixtures that are presented as formulations according to the principles of the instant invention. More specifically, when reviewed by someone having at least ordinary skill in the relevant arts, as used in the descriptions of the invention, the terms will in some cases be understood to refer to the classical definitions of an emulsification, a dispersion, a mixture, a solution, a suspension, a colloidal dispersion, and or an admixture, and combinations thereof. In other instances, such classical terminology will be used in less rigid definitional ways to describe the inventive formulations to be mixtures that are in part dispersions, in part suspensions, in part emulsified mixtures, in part admixtures, in part solutions, and combinations thereof.

Having these definitional considerations in mind, one such meaningful way to illustrate the various embodiments of the invention relates to the incorporation of an emulsifying substance such as lecithin or carrageenan into water or in to an emulsifying dispersion according to the invention. As described in other words elsewhere herein, some of those skilled and trained and the fields of technology of the invention will prepare certain of the more challenging to mix ingredients before preparing the final mixture in a way that is often referred to as preparing a sponge and or as preparing a mixture using a sponge technique.

In this practice and procedure for mixing difficult-to-mix ingredients, various of the dry components of the inventive compositions can be mixed together using small amounts of water, milk, or other elements of the contemplated aqueous emulsifying dispersion described herein. When so mixed, the objective is to prepare the difficult-to-mix items, such as lecithin or carrageenan or other items, with a very small quantity of the noted liquid substance to form the noted sponge or to form a mixture using the sponge technique. This is often done with the substantially dry ingredients (i.e. powdered or granulated items that are dried or free of water or other liquids) of the instant invention. For example without limitation, the sponge can be formed or the sponge technique can be employed by mixing all of the dry components together with an amount of liquid that just enables the dry items to form a dough-like and resilient mixture that is no longer a powdered or granulated substance, but more like that dough used to bake breads and pizza crusts prior to baking. Once mixed, the mixture is set aside to “bloom” for preferably between about 15 and 40 minutes, and more preferably for between about 20 to 35 minutes, and even more preferably for about 30 minutes. The term “bloom” is often used in the baking arts to refer to the time needed for a dormant yeast additive to reactivate in situ after having been mixed with flour and water into a bread or other type of dough or dough-like mixture. Here, while applicable for similar descriptions wherein a yeast type component is added to the formulations according to the invention, which is certainly contemplated for purposes of the instant invention, the term bloom also refers to the time needed to form the contemplated sponge mixture. During this time, the dissimilar ingredients within the mixture interact with one another in ways whereby some constituents remain suspended with others, some constituents move into solution with others, and some constituents are assimilated, dispersed, and otherwise emulsified in the resulting mixture.

Depending upon the ingredients being so mixed, it has been found that mixing the ingredients of the invention without the protein constituent can improve the capability for employing the sponge technique or for forming the sponge. After the sponge has had time to bloom, then the protein can be more easily added prior to final mixing with the remaining perhaps more liquid elements of the inventive formulations.

With each of these summarized embodiments, and variations, alternatives, and modifications thereto, in mind, those skilled in the art can further appreciate and understand that the instant invention in all of its various arrangements meets various long felt but continually needed improved compositions and methods therefore that overcome the shortcomings of prior art compositions. What to this day continues to elude those hoping to improve the state of the art, is the inexpensive, easy-to-use, and physiologically beneficial food supplements and compositions of the invention that maximize the available protein in the supplement while minimizing fat and carbohydrate content in an organoleptically satisfactory and acceptable-shelf-life formulation.

What is especially noteworthy of the various inventive embodiments is that the instant high protein content food supplement compositions are compatible for use with a wide-array of dietetic applications and are capable of incorporating a wide range of possible constituent components in formulations suitable for many ultimate dietetic and nutritional purposes. As can be further better understood with reference to the flowing detailed description of the invention, the new and novel formulations of the invention address the many needs that persist in the field with improvements in the state of the art that do not impose any unacceptable costs or increased difficulties in preparing, storing, and using the preferred food supplement compositions.

In discerning the most desirable composition and profile for the water-soluble protein, those having requisite skill in the art often look to the physical properties and composition of the target organism and or tissues that are to benefit from the water-soluble protein to be used. For purposes of adapting the embodiments and compositions prepared according to the principles of the instant invention to athletically beneficial purposes, one would turn to any of the many useful medical and scientific publications that describe the constituent amino acid profile of mammalian and human muscle tissues and proteins, as well as to descriptions of biologically active polypeptides and foods, among other sources of information. One useful source of such information and analysis includes the work entitled Amino Acid Handbook by Richard J. Block, C. C. Thomas, publisher, 1956 (Library of Congress Catalog Card No. 56-9104). At Table V on page 343, the approximate average amino acid composition of all mammalian muscle proteins, is set forth, which is restated as follows:

| | Grams/100 gm |
|---|---|
| Amino Acid | of Protein |
| Arginine | 6.6 |
| Histidine | 2.8 |
| Lysine | 8.5 |
| Tyrosine | 3.1 |
| Tryptophan | 1.1 |
| Phenylalanine | 4.5 |
| Cystine | 1.4 |
| Methionine | 2.5 |
| Serine | 5.1 |
| Threonine | 4.6 |
| Leucine | 8.0 |
| Isoleucine | 4.7 |
| Valine | 5.5 |
| Glutamic Acid | 14.6 |
| Aspartic Acid | 8.0 |
| Glycine | 5.0 |
| Alanine | 6.5 |
| Proline | 5.0 |
| Hydroxyprolin | 4.7 |

On pages 272-273, of the Amino Acid Handbook the amino acid profile of human muscle tissue is also similarly described.

The instant invention is easily custom tailored to establish a quality protein replenishment source to athletes engaged in various types of strength and endurance conditioning. As described in part elsewhere herein, under the generally applied rules of thumb and customary recommendations advanced by and known to those skilled and knowledgeable in the body building, and the strength and endurance conditioning fields, it is generally accepted that high-quality, easily digestible, and quickly assimilable high-protein foods, food supplements, and food additives be ingested at a rate of preferably between about 1.0 and about 10.0 grams per day per kilogram of body weight, and more preferably between about 1.0 and about 5.0 grams per day per kilogram, and even more preferably between about 1.0 and 3.5 grams per day per kilogram.

One suitable commercially available protein supplement that has been found to be satisfactory for use in connection with the embodiments of the instant invention includes what is termed the “Superior Amino 2222 Liquid” from Optimum Nutrition, Sunrise, Fla., USA. This whey and hydrolyzed gelatin protein supplement presents in a 52-milliliter volume approximately 22.22 grams of protein. In the sweetened formulation sold through retail and wholesale supply sources, an additional 6 grams of carbohydrates is present in the form of dissolved crystalline fructose-type sugars. Other types of similarly effective protein sources can be custom specified and ordered from a host of US-based manufacturing and supply resources. Additionally, many other so-called off-the-shelf protein sources, supplements, and additives are also available in retail, wholesale, and private label marketing and supply channels. Also available from Optimum Nutrition is a powdered form of protein entitled “Instantized 100% Whey Protein,” which has been found to be a suitable source of hydrolyzed whey peptides and proteins. Yet another even more preferable protein source includes the XAP™ and Body for the Ages™ brand anabolic proteins entitled Human Muscle Protein and Cardio Soy Protein, which are available from Body for the Ages in San Francisco, Calif., USA, www.bodyfortheages.com.

In order to demonstrate some of the many possible preferred and optional embodiments of the present invention, the following examples are described and will be helpful and of value to those skilled, knowledgeable, and trained in the relevant fields of technology.

### EXAMPLE 1

In each of many exemplary formulations according to the principles of the instant invention, the dry components of the inventive respective protein-maximized, fat and carbohydrate minimized liquid food supplement composition were blended together in a dry mixture state for approximately 2 minutes to form a uniformly blended or homogenous mixture. This was accomplished in various ways and depended upon the respective concentrations of each of the constituent ingredients. The procedures, practices, and methods for preparing the premixed components included various of the previously described mixing procedures wherein, if needed, certain of the ingredients were mixed together to form a sponge. Once the ingredients in the sponge had bloomed sufficiently to enable further mixing, which more often than not seemed to occur within about 30 minutes or so and which varied somewhat depending upon the precise relative amounts of the constituents of the mixture, the remaining constituents were then added and mixed. In the first example, many iterations of varied quantities of the preferred ingredients were combined, mixed, measured, and tested and sampled, and a wide range of acceptable relative quantities of constituents were found to be very satisfactory. In one particularly preferred composition, the dry components included about 250 grams of water soluble, partially hydrolyzed whey protein powder available from Optimum Nutrition, www.optimumnutrition.com, and about 12 grams of a non-nutritive intense sweetening agent known in the art as a sucralose available from Splenda, Inc., www.splenda.com.

Next, the wet components in the form of the contemplated were added which included the aqueous emulsifying dispersion in the form of 483 grams of whole bovine milk, which contains approximately 16 grams of additional milk protein solids on average. Also, included in the aqueous emulsifying dispersion is a flavoring agent, which for purposes of example without limitation was selected to be vanilla extract in an amount of about 2.5 grams. To establish a well-mixed, homogenous mixture, the wet and dry components were mixed for a brief period of about 20 minutes with a commercial mixing and blending machine at slow mixing speed and the volume was left to settle and then measured to ensure minimal air entrapment during the initial volume and mass measurements. As those skilled in the art may be able to comprehend, with respect to the final total approximate weight of about 748 grams of the composition described here, the protein amounts to about 33.5% of the total weight, the sucralose intense sweetener is about 1.6% by weight, and the milk is about 64.5% by weight. As described below, various flavoring agents may account for some additional portion of the overall inventive composition. Further, as be desirable for certain users of the embodiments of the invention, various coloring agents may also be added to present an appealing or thematic appearance. Children suffering from various ailments may be more inclined to voluntarily partake of a brightly colored product that could be blue, green, orange, red, and other colors so as to correspond perhaps a temporally proximate holiday or other theme.

The mixture was then apportioned into multiple containers and stored at various commercial refrigeration temperatures for periods of time that varied by container from several hours to several weeks. After each period of time assigned to particular containers had passed, observations were made to ascertain shelf-life stability of the mixed ingredients. The mixed and stored food supplement compositions of the invention evidenced excellent stability of the mixture and were found to present little change in the viscosity, flavor, appearance, or aroma over periods of time extending many weeks.

Additionally, after the brief mixing period and recordation of final volume and mass of another batch similarly prepared, the inventive composition was transferred to a mechanical mixing vertical ice cream freezing machine until the mixture temperature was reduced to about 40 degrees Fahrenheit (° F.). In substantially similar volumetric quantities, diary and non-diary based regular, low fat, skim bovine, lactose free, and soy milks (regular, condensed, and evaporated), and no fat yogurts, sweetened and unsweetened, gelatins (such as Jello® type clear gelatins), prepared puddings, were all also found to be substantially compatible for use in conjunction and interchangeably in place of the bovine milk so as to establish an equally satisfactory aqueous emulsifying dispersion.

The mixture maintained acceptable workability viscosity throughout the mixing and cooling process thus far and was easily storable in the present form in refrigeration units, where such refrigerated storage could be maintained for at least many days and for periods of time comparable to the shelf-life of milks, gelatins, puddings, and yogurts without substantial changes in the viscosity or palatability of the mixture. The volume was measured so that post-freezing air entrapment overrun effects could be ascertained. Additional post mixing and pre-freezing pasteurization, sterilization, and additive preservative techniques have been observed and are known to further extend shelf life. Additionally, various techniques for drying the mixture and forming into a powder for later reconstitution have been found to extend the shelf-life far longer using such methods as freeze, spray, roller drum, and other drying techniques, which enable as a food additive for a number of possibly desirable applications including baking, beverage, and other formulations.

In the horizontal mixing apparatus, overrun volumes that incorporated air into the mixture and expanded the volume of the mixture were easily adjustable to achieve 25%, 50%, and 60% (and sometimes higher) overruns or incorporation of air, which overrun air volumes were found to be a function of speed of mixing and time of mixing, as well as the viscosity of the ready-to-cool and freeze food supplement composition of the invention.

For purposes of clarification, the term overrun is customarily used by those skilled in the art to refer to the process by which air is drawn into a mixture in the form of very small bubbles during the cooling process usually employed in horizontal and vertical freezing equipment. Customarily, in the hard and soft-serve ice manufacturing processes most commonly employed by those skilled in the art, ice cream type compositions are preferably cooled and semi-frozen in horizontal type freezers or ice cream machines so as to lessen the overall overrun of the cooled mixture. As the mixture is cooled to between about 35 to about 45 degrees Fahrenheit, and more preferably about 40 degrees Fahrenheit, it is then transferred to containers in which the mixture is then flash frozen to storage and delivery temperatures suitable for the particular ice cream being manufactured.

In preparing mixtures of food supplement compositions of the present or instant invention being described here, it has been found in general that a softer more ready to consume product is often more preferable to the consumer. As a result, it has been discovered that the inventive high protein composition can be better prepared, for various of the exemplary formulations described here and contemplated hereby, with horizontal batch-type ice cream freezers before transfer to delivery and storage containers. This is primarily because greater overrun, or air volume, can be drawn into the mixture during freezing. The greater air volume results in softer and more pliable post freeze product that is easier and more convenient to consume than the more firm ice-cream-type compositions.

Next, the mixture was transferred in portions of about 4 ounces to serving cups for further post-cooling, flash and regular freeze testing. Both flash and regular freezing methods presented similar results. After freezing was complete in standard temperature commercial freezer units, samples were removed for organoleptic testing. A firm and solid composition was presented with about 20% overrun volumes, which became more pliable with an 8 second heating in a 1000-watt microwave unit. After heating, the composition remained frozen but was found to be more easily pliable with a spoon. Similar pliability results were also obtained with increased overrun volumes, which amplified frozen-state pliability was achieved with overrun volumes of approximately 50%, plus or minus about 10%. With the horizontal freezing process, the quantity and size of the air bubbles was found to be enhanced such that post-freeze pliability was increased to the point that post-freeze, pre-consumption microwave heating was unneeded. Further, freezer storage and refreezing was satisfactory over the span of 2 day, 7 day, 14 day, 30 day, and 45-day periods of time without degradation of pliability and without macroscopic appearance of ice or protein crystals.

Excellent organoleptic properties were also observed in that a smooth and creamy mouth feel and a favorable flavor and aroma were perceived and reported by three taste testers. Substrate graininess was not found after initial cooling and freezing, or after a 30 or 45-day storage period. Additionally, smoothness and creaminess was perceived and reported to be enhanced with increased overrun formulations. In yet other alternative variations of the preceding embodiments, about 2.6 grams of vanilla extract or flavor-enhancing equivalents of cocoa powder and other desirable flavors were added to the pre-cooled, pre-frozen mixture for added flavoring, which produced similarly pleasing and appealing results.

### EXAMPLE 2

What is commonly referred to by those knowledgeable in the relevant arts as a lime sherbet or sherbet-like formulation was also prepared employing similar mixing, cooling, and freezing procedures as described in connection with Example 1 and the preceding descriptions of preferred and optional practices, methods, and procedures. Although termed a sherbet here, those having skill in the art may be able to comprehend that the formulations according to the invention may overlap the various classical definitions of a sherbet, sorbet, ice cream such that use of the term sherbet is meant only to illustrate the inventive embodiments.

In other words, although formulations of the invention may be termed a frozen preparation, a sherbet, a sorbet, an ice cream, a frozen yogurt, it is intended that such terms are not be interpreted rigidly or rigorously, but instead are to be understood in the context of one having skill in the art, who should comprehend the myriad overlap in definitional terminology as used in the various relevant fields of technology. For example, many of those knowledgeable in the related fields of art would comprehend that although a sorbet typically only includes frozen fruit juices, it can include a milk-type component for improved smoothness, but still be termed a sorbet. In the strict classical definitions, such a modified sorbet would be termed a sherbet, however that is not always the case.

This next formulation of interest in the present example resulted in a similarly satisfactory food and food supplement and additive composition having excellent pre-freeze and post-freeze shelf-life, storage performance, and satisfactory before and after organoleptic properties. The preferred composition was found to be satisfactory when formulated to incorporate a diary or soy milk based aqueous emulsifying dispersion in an amount of about 483 grams, which presented additional vegetable protein. The aqueous emulsifying dispersion also incorporated a lime juice concentrate in an amount of about 205 grams, an intense sucralose-based sweetener, a flavoring agent such as vanilla in an amount of approximately 2.6 grams, and an anabolic water soluble protein in an amount of about 360 grams.

As with preceding embodiments, when prepared using generally vertical cooling and freezing equipment, the later frozen composition was found to be substantially hardened and less pliable than desired as a result of the less than preferred overrun, or air bubbles imbedded into the cooled composition. While these properties are satisfactory for ice cream style frozen food supplement sherbet-type compositions of the invention, when a more soft end-product is desirable, such as what is commonly referred to by those skilled in the as a “soft serve ice cream”, a generally softer, more pliable post-freeze food supplement composition is usually more preferred. However, this occasionally more preferred embodiment is easily obtained with, for example, a 4 ounce portion that was subjected to a 1000 watt microwave heating cycle of about 8 seconds, which rendered the more firm ice-cream-like composition in a substantially frozen but far more pliable state ready for consumption.

### EXAMPLE 3

In yet other examples of the organoleptically satisfactory food compositions of the present invention, as needed and in accordance with the practices and procedures described elsewhere herein, a high protein yogurt composition was prepared with many variations and ranges of varied constituent ingredients. While a large number of satisfactory compositions were prepared, one optionally preferred composition was prepared using a low fat milk-based unsweetened yogurt in an amount of about 483 grams mixed with about 242 grams of low fat milk. Next, about 250 grams of a powdered whey protein admixed with about 6 grams of an intense sweetener, namely Splenda®, were combined with the milk and yogurt and mixed for a brief period of about 20 minutes. The additional protein constituents of the yogurt include about 4.3 grams and those of the low fat milk include about 8.5 grams for a total from the yogurt and milk of about 12.8, which increases the overall protein content of the final mixture to about 262.8 grams of protein. Any of the possibly desirable flavoring agents contemplated herein may also be incorporated, which flavoring agents may also be pre-incorporated in any of the other components and for any of the other embodiments described here in connection with the present example and elsewhere herein. For example, the protein powder may sometimes be ordered with a vanilla and or other flavoring already added thereto.

After the brief mixing, a portion of the mixture was set aside for refrigeration and storage over an extended period of time, while the remaining portion was processed in a horizontal freezer or ice cream maker for a period about 35-40 minutes until the mixture was cooled to about 40 degrees Fahrenheit. Then the mixture was apportioned into 4 ounce containers for final freezing. Samples of the frozen food supplement composition were observed and tasted at several points over a period of the following several weeks to assess immediate post-freeze taste, appearance, aroma, and pliability properties. The inventive yogurt based food supplement composition was found to be especially satisfactory in terms of overall organoleptic appeal in that a smooth and silky texture and pleasing taste were experienced. As time progressed, the later samples become more firm and less pliable such that it was preferred to briefly expose the 4 oz. samples to an 8 second microwave radiation burst, which left the sample still substantially frozen but much more pliable for convenient consumption.

Regular and periodic observation of the liquid refrigerated mixture revealed good shelf life comparable to but slightly longer than that of milk. As contemplated with other examples, post mixing pasteurization or other sterilization and preservation methods including the addition of various preservatives have been found to extend the refrigerated shelf-life somewhat longer. Similarly satisfactory embodiments were also demonstrated replacing the yogurt components with gelatins including clear gelatins and puddings.

### EXAMPLE 4

Using many of the preceding principles, methods, and compositions of the preceding examples and illustrations of the embodiments of the instant or present invention, various types of sorbet preparations were also investigated using many ranges of respective constituent ingredients. While many suitable food supplement compositions were found to be organoleptically satisfactory, several were found to be especially preferred in view of pleasing taste, smooth texture, long shelf life, and especially high protein content.

One such particularly satisfactory inventive composition included a flavored liquid high-protein content supplement in an amount of about 537 grams, which presented an efficacious amino acid profile well-suited to its nutritional purpose in the instant invention. While several excellent manufacturers and suppliers of such products exist today, one particular product was demonstrated to exhibit exceptional compatibility for purposes of the invention. The Super Amino 2222 liquid available from Optimum Nutrition was incorporated as stated in an amount of about 537 grams, in which about 221 grams of hydrolyzed and whey protein are available. In addition, various appealing flavoring agents may be requested when ordering. Here, in this example a raspberry flavoring agent was presented which demonstrated unopposed appeal among those sampling the various alternatives of the embodiments of this example.

Next, about 400 grams of water and about 24 grams of a sucralose intense sweetener available as the Splenda® product were incorporated and mixed until a homogenous mixture was obtained. A second batch was also prepared in the same way except that about 732 grams of the flavored liquid high-protein supplement was added. The sorbet mixtures were apportioned into about 2.5 oz. popsicle-type freezer trays and frozen. A portion of each mixture was also set aside for refrigeration over extended period to observe for shelf-life analyses. After freezing, samples were inspected over the course of subsequent days and weeks. Inspection of the set aside refrigerated portions revealed no degradation in the mixture, which remained substantially transparent with no perceptible precipitates, and which retained its pleasing aroma, taste, and smooth texture. Similarly, the frozen popsicle type sorbets were found to freeze well into hardened ices. The frozen sorbet or popsicles retained their frozen state for at least as long as other types of popsicles and sorbets such that consumption was not required in unduly short periods of time any different than other similarly fabricated sorbet ice food supplement compositions. The iced versions were also easily shaved and refrozen into more conventional sorbet serving arrangements that proved very appealing in taste, smooth texture, and aroma. In view of the exceptionally high protein content of the sorbet preparations, and in the context of post-strenuous work-out and or summer time consumption opportunities, these alternative inventive food supplement compositions were found to be among the most preferred among those who tested the many various embodiments of the invention.

For applications where a softer ice was preferred, such as that obtained from shaving the hardened ice embodiments, it was demonstrated that the pre-frozen mixture could be cooled in conventional horizontal freezing or ice cream-type machines to entrap or entrain certain amounts of air into the mixture (also known as establishing an overrun into the mixture to be frozen) prior to freezing so as to produce softer ices upon freezing. Even more preferably, processing and cooling in a horizontal batch freezer was found to be especially efficient in establishing even greater overrun and consequently softer post-frozen iced versions of the high-protein food supplement compositions of the present invention.

As with preceding examples, with proper food preparation sanitary methods in place, the shelf-life of the liquid and frozen configurations of the present embodiments were demonstrated to be nearly indefinite. Even so, various types of pasteurization, sterilization, and preservative additives may also be employed with these inventive embodiments to preserve freshness for extended periods of time.

### EXAMPLE 5

Various improvements were also incorporated into some of the preceding examples to further evidence particularly appealing embodiments of the high-protein content food supplement compositions according to the principles of the instant invention. With respect to the immediately preceding examples, a hybrid sorbet-sherbet composition was prepared with a focus on presenting a less iced, smoother tasting and textured version of the invention. To that end, the previously described flavored liquid high-protein content supplement was incorporated in an amount of about 245 grams and mixed with equal amount of water. However, in this instance, approximately 9 grams of the already described intense sucralose sweetener was added along with about 7 grams of a pyruvate creatine mixture, such as that available from the Body for the Ages company noted above.

Also, to partial emulsify several of the constituents of the Example 5 mixture so as to soften and increase the palatability of the final iced product, about 25 grams of a powered whey lecithin component was to be added to the mixture. Before adding the fatty oil lecithin product, a sponge mixture or a mixture prepared using the sponge technique already described, was first prepared with the lecithin to ensure and enable a more homogenous mixing with the preceding components.

To prepare the lecithin sponge, the dry lecithin was mixed in a suitable vessel along with just enough water to create a doughy mixture during a 2 minute period of mixing time. Even more preferably, all of the dry constituent ingredients were combined using the sponge technique, except for the protein. The resultant was left in refrigeration for about 30 minutes so that the lecithin would become hydrated with the liquid component and or the water to form or bloom into a sponge-like mixture. Once the sponge was ready, if the protein had not already been added, the sponge mass was mixed for about 2 minutes more until smooth, uniform, and consistent. If not already added to the instant mixture, the resultant mass was then slowly churned for about 25 minutes into the previously prepared liquid protein, water, sucralose, pyruvate creatine mixture. If previously all such components were mixed, then the mixture was moved directly to the cooling step below without the need for 25 minutes of additional mixing.

Once the substantially homogenous mixture was thereby either mixed to the desired consistency and or cooled to approximately 40 degrees Fahrenheit, a portion of the liquid was set aside for observation of the refrigerated liquid shelf-life, and the remaining quantity was apportioned into 4 oz. serving containers and 2.5 oz. popsicle-type freezer trays for final freezing. Observations of the refrigerated liquid established that no substantial changes were apparent over the course of several weeks.

Periodic sampling of the frozen 4 oz. and popsicle portions demonstrated remarkable results very different from the non-lecithin-based sorbet described earlier. The portions both exemplified organoleptic properties that would have been expected of a lightly shaved sorbet ice composition or of a milk-based (diary or otherwise) sherbet. Moreover, while the taste remained very pleasing and appealing with only a hint of the somewhat nutty flavor of the lecithin, a very smooth and silky non-icy texture was perceived in the samples. Additionally, over the course of several weeks of having remained in the frozen state, the sorbet of this example remained somewhat softer than that of the more iced and frozen water-like composition of Example 4.

Additional experiments included incorporation of various amounts of overrun in both horizontal and vertical batch freezers (ice cream making machines) demonstrated frozen sorbet compositions that were even softer and more silk-like and smooth in organoleptic texture and mouth feel. In some earlier test batches, it was found that the lecithin additive would result in a more grainy texture and a less homogenous appearing and tasting final food supplement composition. With the continued tests, it was discovered that the sponge preparation and then subsequent churning resulted in the unexpected smoother and softer sorbet inventive food supplement composition. As a result, it was deemed to be conclusive that the lecithin sponge and subsequent intermixing thereof created another type of desired aqueous emulsifying dispersion resulting in the additionally preferred embodiment described here. Thus, in addition to demonstrating yet another low fat, low carbohydrate, high-protein content food supplement composition, additional benefits of the inventive composition are presented in the way of the phosphytidal choline and inositol constituents of the lecithin additive.

### EXAMPLE 6

In yet further examples of the embodiments of the instant invention, efforts were also directed at additional reduced fat and reduced carbohydrate milk and non-milk alternatives of various of the preceding preferred and optional embodiments that could incorporate the benefits of the lecithin additives described in connection with Example 5. Here, low fat bovine milk and yogurt composition, as well as a soy milk composition, were prepared according generally to the procedures and with the component quantities of example 3. Here, however, about 24 grams of lecithin was added to the composition. In this series of preparations that resulted in this particular example, it was also discovered that too much overrun by way of whipping created, after freezing, a solid mass that seemed as hard as ice. Thus, it was concluded that moderate churning as accomplished in preceding examples avoided the harder and more firm ice-like resultant and instead produced the desired post-freeze pliability of the resultant.

With similar shelf-life of the liquid and the frozen product, both the low fat bovine and soy milks versions produced a very smooth and silk texture (organoleptic mouth feel) and pleasing flavor much that obtained when using real, whole milk. Versions of these same embodiments using whole milk and whole milk based yogurt established even smoother and more silky (mouth feel), almost creamy organoleptic properties. One noted organoleptic property of the soy milk version not noted with respect to other examples was that the frozen product resembled what those knowledgeable in the art may refer to as a “fudge-cicle,” which is a chocolate flavored popsicle treat for children having a frozen but fudge-like or sherbet-like mouth feel and consistency found to be very appealing to some tasters. Here again, puddings and gelatins were found to be interchangeable in certain formulations with the yogurt components with often times equally satisfactory organoleptic properties.

### EXAMPLE 7

Next, using some of the procedures and practices described elsewhere herein for preparing the various embodiments of the invention and the variations and alternatives thereof, even lower fat and lower carbohydrate versions of the inventive high-protein food supplement compositions of the previous optional and preferred embodiments were sought. In this instance, another series of preparations identical to those of examples 3 and 6 were prepared using similar procedures and quantities of constituents using skim milk and fat free yogurt. In this instance, the final product retained the smooth and silky texture of examples 2 and 6 with slightly greater sense of the protein taste and flavor, and only a slight icy texture being manifest in the final product. While not the most preferred of the various embodiments demonstrated to those tasting and qualifying the various versions, in view of the no fat and virtually zero carbohydrate properties of this high-protein food supplement composition, all tasters unequivocally agreed that the fat free, no carbohydrate version was especially pleasing and appealing not only with respect to the taste and mouth feel aspects, but also especially with respect to the pronounced nutritive qualities. All other factors and properties of this exemplary version also remained within the acceptable bounds determined with the preceding examples.

### EXAMPLE 8

Yet other variations were also prepared using 2%, 1%, and skim milk components as the aqueous emulsification dispersion base. As expected, as the fat content of the aqueous emulsification base was decreased, a less smooth and silky and a more icy, harder, and slightly more grainy texture end product resulted. Thus, it was concluded that variations in the most preferred organoleptic properties could still achieve the desired higher-protein contents and the consumer could select the desired degree of trade off based upon the nutritive goals and objectives of the individuals: maximized nutritive benefit versus most appealing taste and texture and mouth feel.

In sum, while a wide range of possibly desirable formulations of the high-protein content food supplement and additive compositions are possible, various ranges of quantities of components and constituents established more preferable resultant compositions. Variations of any of the preceding embodiments also included substitute liquid protein preparations as well as interchanged powered protein supplements with equally desirable results and taster feedback. Thus, substantial industrial utility is demonstrated.

### EXAMPLE 9

Various of the preceding preferred and optional embodiments of the inventive high-protein content food supplement and additive compositions, and some of the variations and alternatives thereof were also prepared as described for purposes of establishing compatibility for use as food additives in other liquid, solid, and powdered foods. More particularly, the various formulations of the invention were prepared as described and retained in a liquid form that was refrigerated for varying periods of time, and then incorporated into various cold-prepared and cooked foods. While many excellent results were obtained, some especially desirable foods that were found to be easy to prepare and organoleptically desirable included various baked foods such as, for purposes of example without limitation, pancakes, waffles, breads, nutrition bars, breakfast bars, snack foods, and other types of baked and cold prepared foods and confections, all of which were demonstrated to be excellent means by which to deliver the inventive high-protein compositions.

Additionally, similarly satisfactory results were obtained wherein the contemplated inventive liquid composition was employed as a food additive to preparations that are commonly referred to by those skilled in the relevant arts as “smoothies,” “fruit smoothies,” “milk shakes,” “malts,” and the like. In yet further optional or preferred alternatives to various of the preceding embodiments, the inventive formulations were prepared as described and then condensed, evaporated, baked and or dried into a non-leavened or unleavened cake-like or bread-like preparation that was then pulverized into powdered and granulated forms for use as a food additive to various of the described and contemplated foods noted herein. In the best exemplary formulations, the powder or granulated forms were obtained from the cake-like composition that was the result of slow-evaporation, condensing, and baking and drying techniques. Many equally desirable results were obtained, which further established that this proposed dried configuration of the invention was also well-suited as a means by which the high protein food supplement and additive of the instant invention can be prepared and consumed by users.

Numerous alterations, modifications, and variations of the preferred embodiments disclosed herein would be apparent to those skilled in the art and they are all contemplated to be within the spirit and scope of the instant invention, which is limited only by the following claims. For example, although specific embodiments have been described in detail, those with skill in the art can understand that the preceding embodiments and variations can be modified to incorporate various types of substitute and/or additional materials, components, and adjusted relative ratios of constituents and compositions. Such optional or preferred modifications can establish optimized compatibility with the wide variety of possible intended effects, benefits, and likely prospective beneficiaries of the foods, food supplements, and food additives contemplated by the principles of the instant invention. Accordingly, even though only few such embodiments, alternatives, variations, and modifications of the present invention are described herein, it is to be understood that the practice of such additional modifications and variations and the equivalents thereof, are within the spirit and scope of the invention as defined in and as limited only by the following claims.

1. A protein-maximized, fat and carbohydrate minimized liquid food supplement composition, comprising:
a) between about 30% and about 65% by weight water soluble protein;
b) less than about 3% by weight of a non-nutritive intense sweetening agent;
c) between about 0.1% and about 5% by weight of a flavoring agent; and
d) between about 27% and about 70% by weight of an aqueous emulsifying dispersion.

2. The protein-maximized, fat and carbohydrate minimized liquid food supplement composition of claim 1 wherein the between about 30% and about 65% by weight water soluble protein includes an amino acid profile with between about 4.5% and about 7.2% by weight of alanine, between about 2.6% and about 6.0% by weight of arginine, between about 5.0% and about 9.5% by weight of aspartic acid, between about 2.0% and about 5.0% by weight of cystine, between about 12.0% and about 17.0% by weight of glutamic acid, between about 2.0% and about 4.5% by weight of glycine, between about 2.0% and about 4.0% by weight of histidine, between about 3.0% and about 5.0% by weight of isoleucine, between about 9.0% and about 11.0% by weight of leucine, between about 7.0% and about 10.5% by weight of lysine, between about 1.5% and about 2.5% by weight of methionine, between about 5.0% and about 8.0% by weight of phenylalanine, between about 6.0% and about 15% by weight of proline, between about 5.0% and about 9.0% by weight of serine, between about 5.0% and about 8.5% by weight of threonine, between about 1.0% and about 3.0% by weight of tryptophan, between about 1.5% and about 4.5% by weight of tyrosine, and between about 6.0% and about 8.0% by weight of valine.

3. The protein-maximized, fat and carbohydrate minimized liquid food supplement composition of claim 1 wherein the protein further incorporates a dietetically effective amount of a pyruvate compound.

4. The protein-maximized, fat and carbohydrate minimized liquid food supplement composition of claim 1 wherein the non-nutritive intense sweetening agent is a sucralose.

5. The protein-maximized, fat and carbohydrate minimized liquid food supplement composition of claim 1 wherein the aqueous emulsifying dispersion incorporates a powdered, hydrated lecithin in an amount of between about 2% and about 10% by weight of the food supplement composition.

6. The protein-maximized, fat and carbohydrate minimized liquid food supplement composition of claim 1 being frozen and wherein the hydrated lecithin is incorporated in an amount of between approximately 7% by weight of the food supplemental composition.

7. The protein-maximized, fat and carbohydrate minimized liquid food supplement composition of claim 1 wherein the aqueous emulsifying dispersion incorporates an organoleptically enhancing reduced fat content milk composition.

8. The protein-maximized, fat and carbohydrate minimized liquid food supplement composition of claim 7 wherein the reduced fat content milk composition is a soy milk.

9. The protein-maximized, fat and carbohydrate minimized liquid food supplement composition according to claim 1 prepared as a sherbet that further includes in amounts by weight of the food supplement composition, the water soluble protein being in an amount of between about 35% and about 45% by weight, the sweetening agent in an amount of between about 1% and about 3% by weight, the flavoring agent in an amount of between about 0.5% and about 2% by weight, and the aqueous emulsifying dispersion in an amount of between about 45% and about 60% by weight.

10. The protein-maximized, fat and carbohydrate minimized liquid food supplement composition according to claim 1 prepared as a sherbet that further includes in amounts by weight of the food supplement composition, the water soluble protein being in an amount of about 42% by weight, the sweetening agent in an amount of about 2% by weight, the flavoring agent in an amount of about 1% by weight, and the aqueous emulsifying dispersion in an amount of about 55% by weight.

11. A protein-maximized, fat and carbohydrate minimized food supplement sherbet, comprising:
a) between about 30% and about 65% by weight water soluble protein;
b) less than about 3% by weight of a non-nutritive intense sweetening agent;
c) between about 0.1% and about 5% by weight of a flavoring agent; and
d) between about 27% and about 70% by weight of an aqueous emulsifying dispersion that incorporates a reduced fat milk composition and a lecithin component in an amount of between about 1.5% and about 7% by weight of the food supplement composition.

12. The protein-maximized, fat and carbohydrate minimized food supplement sherbet according to claim 11 wherein the water soluble protein includes an amino acid profile with between about 4.5% and about 7.2% by weight of alanine, between about 2.6% and about 6.0% by weight of arginine, between about 5.0% and about 9.5% by weight of aspartic acid, between about 2.0% and about 5.0% by weight of cystine, between about 12.0% and about 17.0% by weight of glutamic acid, between about 2.0% and about 4.5% by weight of glycine, between about 2.0% and about 4.0% by weight of histidine, between about 3.0% and about 5.0% by weight of isoleucine, between about 9.0% and about 11.0% by weight of leucine, between about 7.0% and about 10.5% by weight of lysine, between about 1.5% and about 2.5% by weight of methionine, between about 5.0% and about 8.0% by weight of phenylalanine, between about 6.0% and about 15% by weight of proline, between about 5.0% and about 9.0% by weight of serine, between about 5.0% and about 8.5% by weight of threonine, between about 1.0% and about 3.0% by weight of tryptophan, between about 1.5% and about 4.5% by weight of tyrosine, and between about 6.0% and about 8.0% by weight of valine.

13. The protein-maximized, fat and carbohydrate minimized food supplement sherbet according to claim 11 wherein the protein further incorporates a dietetically effective amount of a pyruvate compound.

14. The protein-maximized, fat and carbohydrate minimized liquid food supplement composition of claim 11 wherein the non-nutritive intense sweetening agent is a sucralose.

15. The protein-maximized, fat and carbohydrate minimized liquid food supplement composition according to claim 11 that further includes in amounts by weight of the food supplement composition, the water soluble protein being in an amount of between about 35% and about 45% by weight, the sweetening agent in an amount of between about 1% and about 3% by weight, the flavoring agent in an amount of between about 0.5% and about 2% by weight, and the aqueous emulsifying dispersion in an amount of between about 45% and about 60% by weight.

16. The protein-maximized, fat and carbohydrate minimized liquid food supplement composition according to claim 11 that further includes in amounts by weight of the food supplement composition, the water soluble protein being in an amount of about 42% by weight, the sweetening agent in an amount of about 2% by weight, the flavoring agent in an amount of about 1% by weight, and the aqueous emulsifying dispersion in an amount of about 55% by weight.

17. A protein-maximized, fat and carbohydrate minimized powdered food supplement, comprising:
a) between about 30% and about 65% by weight water soluble protein;
b) less than about 3% by weight of a non-nutritive intense sweetening agent;
c) between about 0.1% and about 5% by weight of a flavoring agent;
d) between about 27% and about 70% by weight of an aqueous emulsifying dispersion that incorporates a lecithin component in an amount of between about 1.5% and about 7% by weight of the food supplement composition; and
wherein the supplement is prepared in a substantially liquid formulation and then dried and refined into the substantially powdered supplement.

18. The protein-maximized, fat and carbohydrate minimized food supplement according to claim 17 wherein the water soluble protein includes an amino acid profile with between about 4.5% and about 7.2% by weight of alanine, between about 2.6% and about 6.0% by weight of arginine, between about 5.0% and about 9.5% by weight of aspartic acid, between about 2.0% and about 5.0% by weight of cystine, between about 12.0% and about 17.0% by weight of glutamic acid, between about 2.0% and about 4.5% by weight of glycine, between about 2.0% and about 4.0% by weight of histidine, between about 3.0% and about 5.0% by weight of isoleucine, between about 9.0% and about 11.0% by weight of leucine, between about 7.0% and about 10.5% by weight of lysine, between about 1.5% and about 2.5% by weight of methionine, between about 5.0% and about 8.0% by weight of phenylalanine, between about 6.0% and about 15% by weight of proline, between about 5.0% and about 9.0% by weight of serine, between about 5.0% and about 8.5% by weight of threonine, between about 1.0% and about 3.0% by weight of tryptophan, between about 1.5% and about 4.5% by weight of tyrosine, and between about 6.0% and about 8.0% by weight of valine.

19. The protein-maximized, fat and carbohydrate minimized food supplement according to claim 17 wherein the protein further incorporates a dietetically effective amount of a pyruvate compound.

20. The protein-maximized, fat and carbohydrate minimized food supplement of claim 17 wherein the non-nutritive intense sweetening agent is a sucralose.

21. The protein-maximized, fat and carbohydrate minimized food supplement according to claim 17 that further includes in amounts by weight of the food supplement, the water soluble protein being in an amount of between about 35% and about 45% by weight, the sweetening agent in an amount of between about 1% and about 3% by weight, the flavoring agent in an amount of between about 0.5% and about 2% by weight, and the aqueous emulsifying dispersion prior drying in an amount of between about 45% and about 60% by weight.

22. The protein-maximized, fat and carbohydrate minimized liquid food supplement according to claim 17 that further includes in amounts by weight of the food supplement, the water soluble protein being in an amount of about 42% by weight, the sweetening agent in an amount of about 2% by weight, the flavoring agent in an amount of about 1% by weight, and the aqueous emulsifying dispersion prior to drying in an amount of about 55% by weight.
